(19) United States
(12) Patent Application Publication
(10) Pub. No.: US 2014/0342325 A1
(43) Pub. Date: Nov. 20, 2014

(54) AUTOMATICALLY GENERATING A CURRICULUM TAILORED FOR A PARTICULAR EMPLOYMENT POSITION

(71) Applicant: APOLLO GROUP, INC., PHOENIX, AZ (US)

(72) Inventor: Mary Wu, Pittsburg, CA (US)

(73) Assignee: APOLLO GROUP, INC., PHOENIX, AZ (US)

(21) Appl. No.: 13/896,652

(22) Filed: May 17, 2013

(51) Int. Cl. G06Q 50/20

(52) U.S. Cl. CPC G06Q 50/2053
USPC 434/219

(57) ABSTRACT

A position-centric approach is provided for creating a curriculum. Under this approach, a curriculum is created for a particular employment position, and the courses that are included in the curriculum are selected based upon the skills that are desired or required for the particular employment position. With such a curriculum, the student is taught the specific skills that are needed to perform well in the employment position. By educating a student using such a curriculum, the student is better prepared for the particular employment position than if the student were educated using a curriculum that is developed based upon a field of study.

### FIELD OF THE INVENTION

The present invention relates generally to education and more particularly to a method and system for automatically generating a curriculum that is tailored for a particular employment position.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Many educational institutions (e.g. universities, colleges, etc.) offer degree plans in a variety of fields of study. For example, a university may offer a degree plan in electrical engineering, history, business administration, accounting, physics, etc. Under each degree plan, there are a variety of courses, with each course pertaining to one or more topics or subjects within the field of study of the degree plan. Together, all of the courses form the curriculum for the degree plan.

Typically, the curriculum for a degree plan is developed based upon the field of study of the degree plan. That is, the courses that make up the curriculum for a degree plan are selected because they teach a topic or subject that is within the field of study of the degree plan. Thus, a curriculum is typically developed in a field-of-study-centric manner (referred to hereinafter as the field-centric approach for developing a curriculum).

Developing a curriculum using the field-centric approach is effective if the goal is to teach a student the different topics and subjects related to a particular field of study. However, in many instances, when a student attends an educational institution, the student's goal is not necessarily to learn the various aspects of a particular field of study. Rather, the goal of the student may be to prepare himself/herself for a job. If preparing for a job is the goal, then a curriculum developed using the field-centric approach may not further that goal very effectively. For instance, a particular job may require skills or know-how that spans across multiple fields of study. In such a case, a curriculum developed for one of the multiple fields of study will not teach the student everything he/she will need to know to perform the job effectively. Also, a curriculum developed for a particular field of study may be overly encompassing in that it may include courses that do not pertain to a particular job. Hence, the curriculum may force the student to needlessly learn topics and subjects that the student will never use on the job. Furthermore, the curriculum may be under encompassing in that it may not include courses that delve into sufficient detail in a particular area that is required for a particular job. Thus, the curriculum may not teach, even in the right field of study, what the student needs to know to perform the job. Hence, for these and other reasons, curricula developed using the field-centric approach often do not adequately prepare students for jobs that are available in the employment world.

### BRIEF DESCRIPTION OF THE DRAWINGS

FIG. 1 is a high level flow diagram of a methodology that can be used to automatically generate a curriculum that is tailored for a particular employment position, in accordance with one embodiment of the present invention.

FIG. 2 is a high level flow diagram illustrating a methodology that can be used to determine a set of desired skills for a particular employment position and to store the set of desired skills into a skills repository, in accordance with one embodiment of the present invention.

FIG. 3 is a flow diagram that shows in greater detail how a set of desired skills may be determined for a particular employment position, in accordance with one embodiment of the present invention.

FIG. 4 is a functional block diagram of a system in which one embodiment of the present invention may be implemented.

FIG. 5 is a block diagram of a computer system that may be used to implement at least a portion of the present invention.

### DETAILED DESCRIPTION OF EMBODIMENT(S)

### Overview

In accordance with one embodiment of the present invention, a position-centric approach is provided for creating a curriculum. Under this approach, a curriculum is created for a particular employment position, and the courses that are included in the curriculum are selected based upon the skills that are desired or required for that particular employment position. With such a curriculum, the student is taught the specific skills that are needed to perform well in the employment position. By educating a student using such a curriculum, the student is better prepared for the particular employment position than if the student were educated using a curriculum developed using the field-centric approach.

Under the position-centric approach, courses may be designed and developed by educators differently. Rather than developing courses to teach certain topics or subjects under particular fields of study, educators may design and develop courses to teach one or more specific skills. These skills may correspond closely with the skills that are desired or required by certain employment positions. Developing courses to teach specific skills (i.e. developing courses using a skills-centric approach) enables the courses to be easily selected and incorporated into curricula that are generated for particular employment positions based upon the skills that are desired or required for those particular employment positions. A skill may be desired or required by more than one employment position; thus, a course that teaches a certain skill may be included in the curriculum of multiple employment positions.

As used herein, the term “employment position” refers to a position for which there may be employment opportunities. An employment position may, for example, be viewed as a type of job, a specific job title, a specific type of job position, etc. Examples of employment positions include, but certainly are not limited to, circuit design engineer, emergency room doctor, financial analyst, patent secretary, systems administrator, interior designer, history teacher, etc. When the term a “particular employment position” is used, reference is being made to a specific employment position but not to a specific instance or opening for a specific employment position. For example, a particular employment position may be “history teacher” but it would not be a specific instance of a history teacher at school X in city Y. The specific instance or opening may be better thought of as a specific opportunity or a specific instance of employment for the particular employment position.

For maximum efficacy, an employment position should not be too encompassing. For example, it may not be desirable to have an employment position that is as broad as “engineer” but rather it may be desirable to have a more defined employment position such as “circuit design engineer”. The more defined an employment position is, the more likely it is that a tailored curriculum can be created to teach the skills that are desired or required for that employment position.

As used herein, the term “skill” refers broadly to any characteristic, asset, knowledge, quality, know-how, ability, proficiency, experience, expertise, etc., of an employee that would be desired or required for an employment position. As non-limiting examples, a skill may be an ability to do something (e.g. speak a certain language, type at a certain speed, program in a certain programming language, etc.), knowledge of a particular field or topic (e.g. knowledge of a certain area of law, knowledge of statistics, etc.); familiarity with certain tools or aids (e.g. spreadsheet software, computer aided design software, oscilloscope, etc.), ability to perform certain tasks (e.g. analyze financial statements, create computer models, etc.), experience in certain areas (e.g. experience as a manager, experience in certain fields, etc.), etc.

### Methodology Description

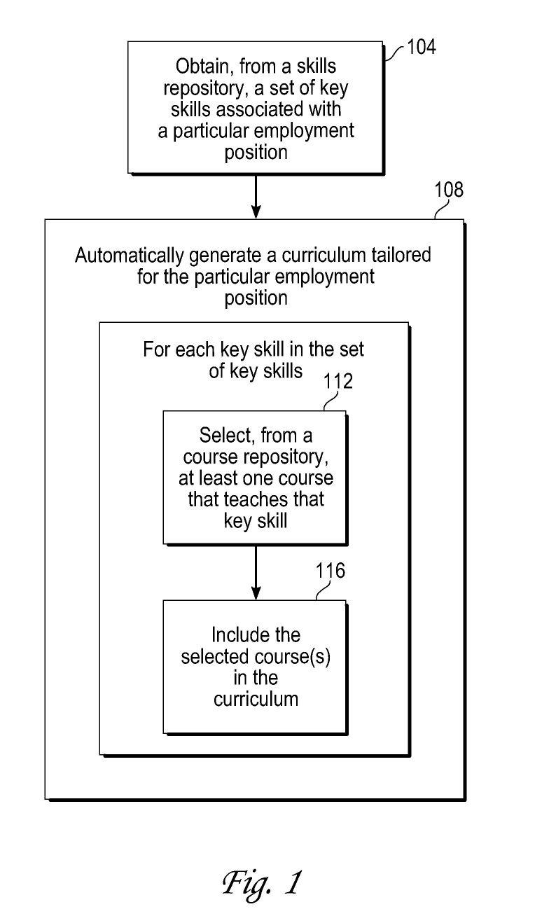

In one embodiment, a curriculum tailored for a particular employment position may be automatically generated as shown in the flow diagram of FIG. 1. Initially, a set of key skills associated with a particular employment position is obtained (block 104) from a skills repository. Then, based at least in part upon the set of key skills, a curriculum that is tailored for the particular employment position is automatically generated (block 108). Specifically, for each key skill in the set of key skills, one or more courses are selected (block 112) from a course repository that teach that key skill. The selected course(s) is included (block 116) in the curriculum for the particular employment position. Since this is done for each key skill, by the time all of the key skills in the set of key skills are processed, the curriculum will include at least one course for teaching each of the key skills associated with the particular employment position. Thus, this curriculum will teach a student all of the key skills that the student will need in order to perform well at the particular employment position.

This same methodology may be used to automatically generate curricula for other employment positions as well. Specifically, for another employment position, another set of key skills associated with that employment position is obtained from the skills repository. Then, based at least in part upon that set of key skills, courses are selected from the course repository that teach those keys skills, and the selected courses are included in a curriculum for the other employment position. The newly generated curriculum will teach a student all of the key skills that the student will need in order to perform well at the other employment position. The particular employment position and the other employment position may have one or more skills in common; hence, the curriculum for the particular employment position and the curriculum for the other employment position may have one or more courses in common.

For purposes of the present invention, the key skills that are stored in the skills repository may make their way into the skills repository in any desired manner. For example, the key skills may be provided by a user and stored into the skills repository via some user interface. Alternatively, the key skills may be received from another component (e.g. another processing component or module, another system, etc.) and stored into the skills repository. As a further alternative, the key skills may be determined by the system that implements the method of the present invention (which will be described in a later section) and stored into the skills repository. In one embodiment, it is the system that implements the method of the present invention that determines and stores the key skills into the skills repository.

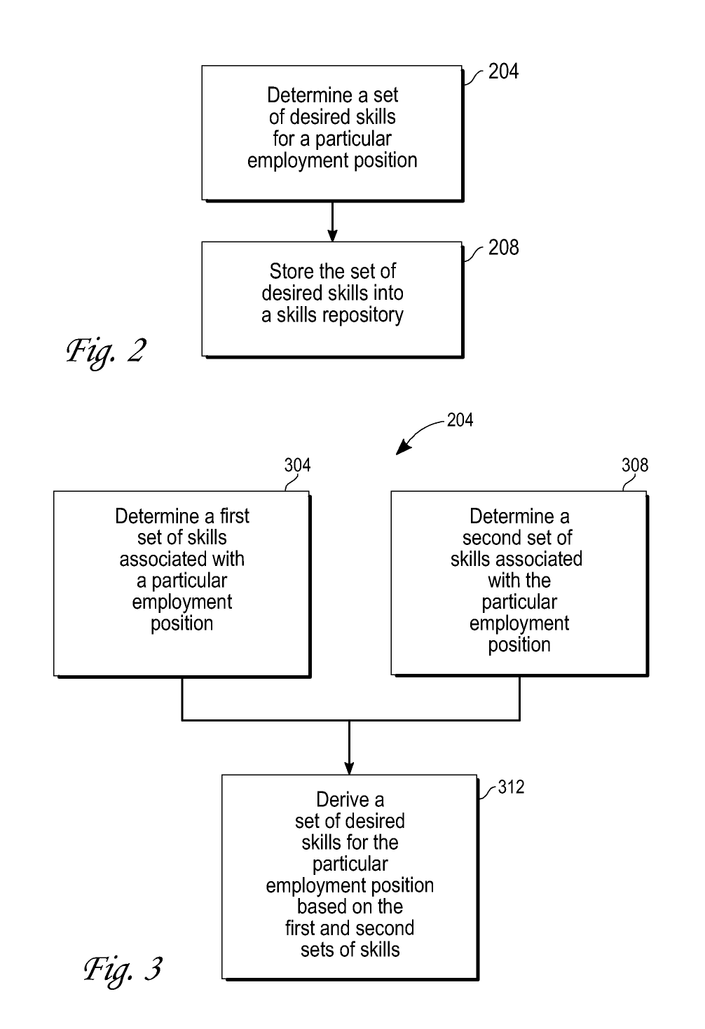

As shown in FIG. 2, the system may determine (block 204) a set of desired skills for a particular employment position. The system may then store (block 208) the set of desired skills into the skills repository in such a manner that indicates that the set of desired skills is associated with the particular employment position. For purposes of the present invention, the set of desired skills that are stored into the skills repository may be the same as the set of key skills that are used to generate a curriculum for the particular employment position, or it may be a superset of the set of key skills. If the set of desired skills is a superset of the set of key skills, then some filtering may be performed when obtaining the set of key skills from the skills repository. For example, if the skills in the set of desired skills are indexed or ranked, then the set of keys skills may be derived by selecting only those desired skills that have index or rank values that are above a certain threshold.

The process shown in FIG. 2 may be used to determine and store sets of desired skills for a plurality of employment positions. Thus, the skills repository may contain a plurality of sets of desired skills, with each set of desired skills being associated with a different employment position.

In FIG. 3, there is shown a flow diagram that illustrates, in greater detail, how the determining operation shown in block 204 of FIG. 2 may be carried out, in accordance with one embodiment of the present invention. As shown in FIG. 3, a set of desired skills for a particular employment position may be determined by initially determining (block 304) a first set of skills associated with the particular employment position. In one embodiment, the first set of skills is determined based upon objective information that is gathered and processed. A second set of skills associated with the particular employment position may also be determined (block 308). In one embodiment, the second set of skills is determined based upon subjective information from employers. Then, based at least in part upon the first set of skills and the second set of skills, an overall set of desired skills may be derived (block 312) for the particular employment position. In one embodiment, it is this set of desired skills that is stored into the skills repository. In the embodiment shown in FIG. 3, the set of desired skills is derived using both the first and second sets of skills. This is not required. If so desired, the set of desired skills may be derived based on just one of the first and second sets of skills.

The above discussion of FIG. 3 is relatively high level. To provide additional context for facilitating a complete understanding of the present invention, some specific examples will now be provided. It should be noted, though, that these examples are provided for illustrative purposes only. The present invention should not be limited to these examples. In fact, many other variations and implementations are possible, and all of the possible variations and implementations are within the scope of the present invention.

### Specific Examples

In one embodiment, the operation shown in block 304 of FIG. 3 of determining a first set of skills for a particular employment position may be performed by accessing a plurality of websites, and processing job or employment posting information found on those websites.

Each website may have a plurality of job or employment postings. Each job posting pertains to a specific opening for a specific type of job. On each website, there may be multiple openings for multiple types of jobs. For example, there may be ten openings (and hence ten job postings) for a financial analyst, five openings for a patent secretary, two openings for a history teacher, etc. Typically, a job posting includes at least two sections: (1) a job type or job title section; and (2) a job description section. The job type section specifies the type of position for which a candidate is being sought (e.g. financial analyst, patent secretary, etc.), which is akin to an employment position as that term is used herein. The job description section describes the job and often specifies the desired qualities for a candidate (e.g. education level, experience level, desired skills, etc.). In one embodiment, these sections of each job posting are processed to determine a first set of skills for an employment position.

For example, on a first website, a first job posting may be accessed and processed. Initially, the job type section of the first job posting is processed to determine the employment position to which it pertains. As part of this processing, natural language processing may be used to parse the job type or job title into a plurality of words, filter out extraneous words (e.g. articles, conjunctions, etc.), and form a final employment position. For the sake of example, it will be assumed that the employment position for the first job posting is “financial analyst”. The description section of the first job posting is then processed to extract key terms therefrom. Again, natural language processing may be used to try to “understand” the description. In one embodiment, nouns and verbs are identified as potential key terms. For verbs, different forms and tenses are recognized as being based on the same verb base. For nouns, adjectives and perhaps other nouns within close proximity of the noun may be grouped with the noun to form a descriptive phrase (e.g. financial statement analysis, computer model, etc.). Key terms in the description may be identified in this and other ways. For the sake of example, it will be assumed that the following three key terms are identified in the first job posting: “financial statement analysis”, “computer model”, and “statistics”.

After the key terms are identified, they are included in a set of key terms that are associated with the employment position of the job posting. In one embodiment, each key term has a “frequency count” value. This value is incremented if that key term is found in a job posting for the associated employment position (in one embodiment, if a key term is found multiple times in the same job posting, the frequency count value of that key term is incremented only once). In effect, the frequency count value indicates the number of job postings for the associated employment position in which the key term is found. In the current example, only one job posting for the employment position of financial analyst has been processed; thus, each key term in the set of key terms will have its frequency count value incremented to “1”. Also, in one embodiment, the employment position itself has a “postings count” value. This value is incremented each time a job posting pertaining to that particular employment position is processed. Since, in the current example, only one job posting pertaining to the employment position of financial analyst has been processed, the postings count for financial analyst is incremented to “1”. Hence, after the first job posting is processed, the employment position of financial analyst is identified; it has a postings count of “1”; and it has a set of three key terms (“financial statement analysis”, “computer model”, and “statistics”) associated therewith, with each key term having a frequency count value of “1”. This result is shown below.

Financial analyst (postings count=1)
financial statement analysis (frequency count=1)
computer model (frequency count=1)
statistics (frequency count=1)

Thereafter, a second job posting on the first website may be processed in a similar fashion. Suppose, for the sake of example, that the second job posting is also for a financial analyst, and that the key terms of “financial statement analysis”, “statistics”, and “auditing” are extracted. Because this is another posting for the employment position of financial analyst, the postings count for financial analyst is incremented to “2”. Because the key terms “financial statement analysis” and “statistics” are already in the set of key terms that are associated with the employment position of financial analyst, these key terms have their frequency count values incremented to “2”. Because the key term “auditing” is not currently in the set of key terms associated with the employment position of financial analyst, it is added to the set of key terms, and its frequency count value is incremented to “1”. The result after processing the second job posting is shown below.

Financial analyst (postings count=2)
financial statement analysis (frequency count=2)
computer model (frequency count=1)
statistics (frequency count=2)
auditing (frequency count=1)

Thereafter, a third job posting on the first website may be processed in a similar fashion. Suppose, for the sake of example, that the third job posting is for an employment position of “nuclear physicist”. Suppose further that the key terms of “nuclear reactor”, “quantum mechanics”, and “statistics” are extracted from the description section of the third job posting. Since this is the first job posting pertaining to the employment position of nuclear physicist, the postings count for nuclear physicist is incremented to “1”. In addition, the key terms of “nuclear reactor”, “quantum mechanics”, and “statistics” are established as an initial set of key terms associated with the employment position of nuclear physicist. The frequency count value of each of these key terms is incremented to “1”. Thus, after the third job posting is processed, the results are as shown below.

Financial analyst (postings count=2)
financial statement analysis (frequency count=2)
computer model (frequency count=1)
statistics (frequency count=2)
auditing (frequency count=1)

Nuclear physicist (postings count=1)
nuclear reactor (frequency count=1)
quantum mechanics (frequency count=1)
statistics (frequency count=1)

The remaining job postings on the first website may be processed in a similar fashion. Thereafter, processing may proceed to each of the other websites in the plurality of websites. After all of the job postings on all of the websites have been processed in the manner described above, a complete list of employment positions will have been compiled, and each employment position will have a set of key terms associated therewith. In one embodiment, these key terms represent the first set of skills associated with each employment position. Note that these skills are determined based upon the descriptions in each of the job postings; thus, they are determined objectively based upon objective information.

In one embodiment, the first set of skills associated with each particular employment position may be indexed and ranked. In one embodiment, an index value may be derived for a key term (or skill) by dividing the frequency count value for that skill by the postings count value for the employment position with which that skill is associated. For example, for the financial analyst employment position, the index value for the “financial statement analysis” skill may be derived by dividing the frequency count value for the “financial statement analysis” skill by the postings count value for the financial analyst employment position. This index value indicates the percentage of times the key term “financial statement analysis” appeared in job postings for the financial analyst employment position. An index value may be derived for the other skills associated with the financial analyst employment position in a similar way. Once the index values are derived for all of the skills associated with a particular employment position, the index values may be used to rank the various skills (e.g. from highest index value to lowest index value). This ranking provides an indication of how important each skill is to that particular employment position.

In the manner described above, a first set of skills may be determined for each of a plurality of employment positions, in accordance with one embodiment of the present invention.

Referring again to FIG. 3, in addition to determining a first set of skills for each of a plurality of employment positions, a second set of skills may also be determined (block 308). In one embodiment, the second set of skills may be determined by soliciting and receiving subjective information from employers. This subjective information may be solicited and received in any desired manner.

For instance, live interviews may be conducted with a plurality of employers. During the interviews, the employers may be asked to provide a list of employment positions (open or filled) that are available at their company or firm. For each employment position, the employers may be asked to provide a set of skills that are desired or required for the employment position, and for each skill, an estimation or rating of how important that skill is to the employment position. In one embodiment, the estimation may be provided on a scale of 0 to 100, which can be easily converted to a decimal value that can be used as an index value (e.g. a 90 may be converted to a 0.9 index value). Once the information is received from the various employers, it can be processed to derive an overall list of employment positions, and for each employment position, an overall set of skills desired or required for that employment position. For multiple sets of information received from multiple employers for the same employment position, the information may be aggregated and averaged to derive an overall set of skills for the employment position. For example, all of the skills specified by all of the employers for a particular employment position may be combined to form an overall set of skills for the particular employment position. Then, the estimation value for each skill may be derived by averaging the estimation values provided by the various employers. If an employer does not list a particular skill as being a desired or required skill, then the estimation value for that skill for that employer may be treated as a 0 for purposes of computing the average estimation value. Once this processing is performed, a complete list of employment positions will be produced, and each employment position will have a subjective set of skills associated therewith. This subjective set of skills represents the second set of skills for each employment position.

As an alternative to conducting live interviews, the subjective information discussed above may be solicited from employers via other means, such as through one or more questionnaires. These questionnaires may be sent to employers using any means (e.g. electronically, via regular mail, via fax, etc.) and the responses from the employers may be received using any means (e.g. electronically, via regular mail, via fax, etc.). As a specific example, an electronic mail message (email) may be sent to the employers with a link to a questionnaire that is hosted on a website, and the employers may click on that link to access the questionnaire and to provide the information discussed above. This and other means may be used to solicit and receive information from the employers. After the information is received from the employers, it may be processed in the manner discussed above to derive a second set of skills for each of a plurality of employment positions.

In one embodiment, the second set of skills associated with each particular employment position may be indexed and ranked. In one embodiment, an index value for a skill may be derived by dividing the estimation value for that skill by one hundred. Thus, a skill having an estimation value of 90 will have an index value of 0.9. Once the index values are derived for all of the skills associated with a particular employment position, the index values may be used to rank the various skills (e.g. from highest index value to lowest index value). This ranking provides an indication of how important each skill is to that particular employment position.

In the manner described above, a second set of skills may be determined for each of a plurality of employment positions, in accordance with one embodiment of the present invention.

Referring again to FIG. 3, after the first and second sets of skills are determined for a particular employment position, an overall set of desired skills may be derived (block 312) for that particular employment position based at least in part upon the first and second sets of skills. In one embodiment, the set of desired skills may be derived by aggregating the skills from the first and second sets of skills Like the first and second sets of skills, the set of desired skills may also be indexed and ranked. In one embodiment, the index value for each skill in the set of desired skills may be derived based upon the index values for that skill in the first and second sets of skills. In one embodiment, different weights may be applied to the index values from the first set of skills than to the index values from the second set of skills. For example, a 0.3 weight may be applied to the index values from the first set of skills while a 0.7 weight may be applied to the index values from the second set of skills. This difference in weighting may be used to assign greater importance to one set of skills over the other.

To illustrate how a set of desired skills may be derived for a particular employment position in accordance with one embodiment of the present invention, reference will now be made to a specific example. In the following example, it will be assumed that a 0.3 weight is applied to index values from the first set of skills and a 0.7 weight is applied to index values from the second set of skills.

Suppose that an employment position XYZ is found in both the list of employment positions from the websites (referred to as the websites list) and the list of employment positions from the employers (referred to as the employers list). In such a case, the employment position XYZ will have both a first set of skills and a second set of skills Suppose further that the sets of skills for XYZ are as shown below.

Employment position XYZ from the websites list (first set of skills)
skill A (index value=0.7)
skill B (index value=0.6)
skill C (index value=0.5)

Employment position XYZ from the employers list (second set of skills)
skill B (index value=0.7)
skill A (index value=0.5)
skill D (index value=0.5)

For these two sets of skills, the aggregate set of skills would include skill A, skill B, skill C, and skill D; thus, the set of desired skills for employment position XYZ would include skills A, B, C, and D. In the set of desired skills, the derived index value for skill A would be 0.7 (the index value for skill A from the first set of skills) times 0.3 (the weight assigned to index values from the first set of skills) plus 0.5 (the index value for skill A from the second set of skills) times 0.7 (the weight assigned to index values from the second set of skills), or 0.7(0.3)+0.5(0.7)=0.56. The index value for skill B would be 0.6(0.3)+0.7(0.7)=0.67. The index value for skill C would be 0.5(0.3)+0(0.7)=0.15. The index value for skill D would be 0(0.3)+0.5(0.7)=0.35. Thus, the derived set of desired skills for employment position XYZ in this example would be:

Employment position XYZ (set of desired skills)
skill B (index value=0.67)
skill A (index value=0.56)
skill D (index value=0.35)
skill C (index value=0.15)

The processing described above may be performed for each employment position that is found on both the websites list and the employers list (such employment positions have both a first set of skills and a second set of skills) Once a set of desired skills is derived for a particular employment position, it may be stored in a skills repository (the skills may be stored with or without their index values). If so desired, all of the skills in the set of desired skills may be stored in the skills repository. Alternatively, only a subset of the skills in the set of desired skills (e.g. those having an index value above a certain threshold) may be stored in the skills repository. In either case, the skills are stored in the skills repository in a manner that indicates that the skills are associated with the particular employment position. That way, the desired skills for a particular employment position can be easily obtained from the skills repository.

Some employment positions may appear on only one of the lists of employment positions (the websites list or the employers list). These employment positions will have either a first set of skills or a second set of skills (depending on which list they appear on) but not both. For such employments positions, there are several options. If so desired, no skills may be stored in the skills repository for these employment positions. Alternatively, the skills that are associated with the employment positions (whether they be the first set of skills or the second set of skills) may be stored in the skills repository as the set of desired skills for those employment positions. As a further alternative, only skills from the first sets of skills may be stored in the skills repository, or only skills from the second sets of skills may be stored in the skills repository. For purposes of the present invention, any of these options may be implemented. If skills are stored in the skills repository, it is desirable that they be stored in a manner that indicates that they are associated with a particular employment position.

After the skills repository is populated with sets of desired skills associated with employment positions, the skills repository may be used to generate a tailored curriculum for one or more particular employment positions.

### Sample System

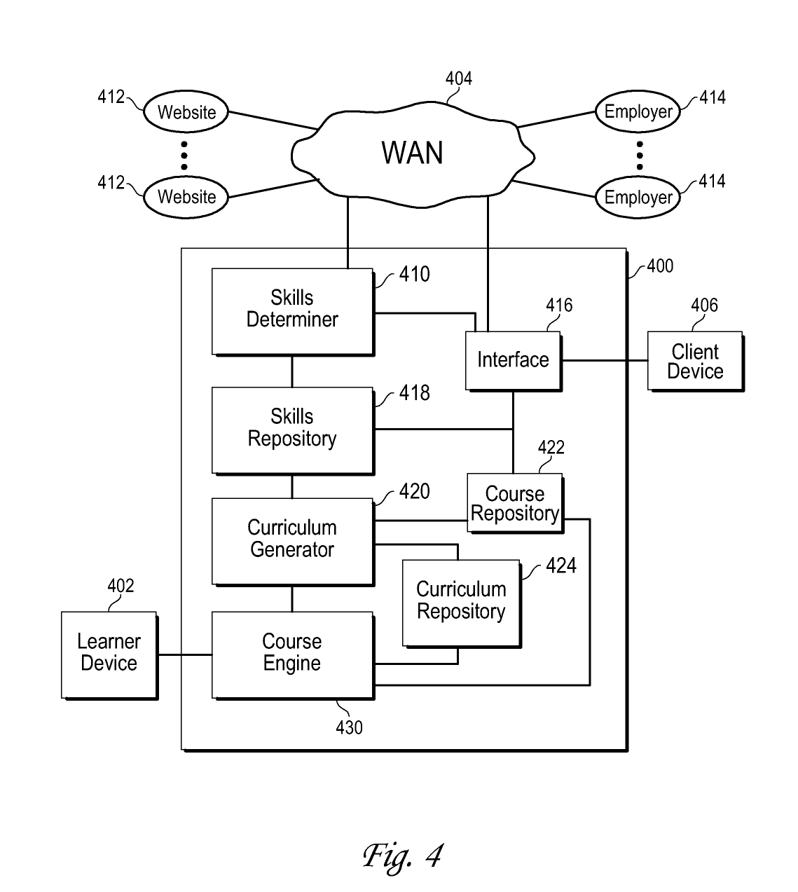

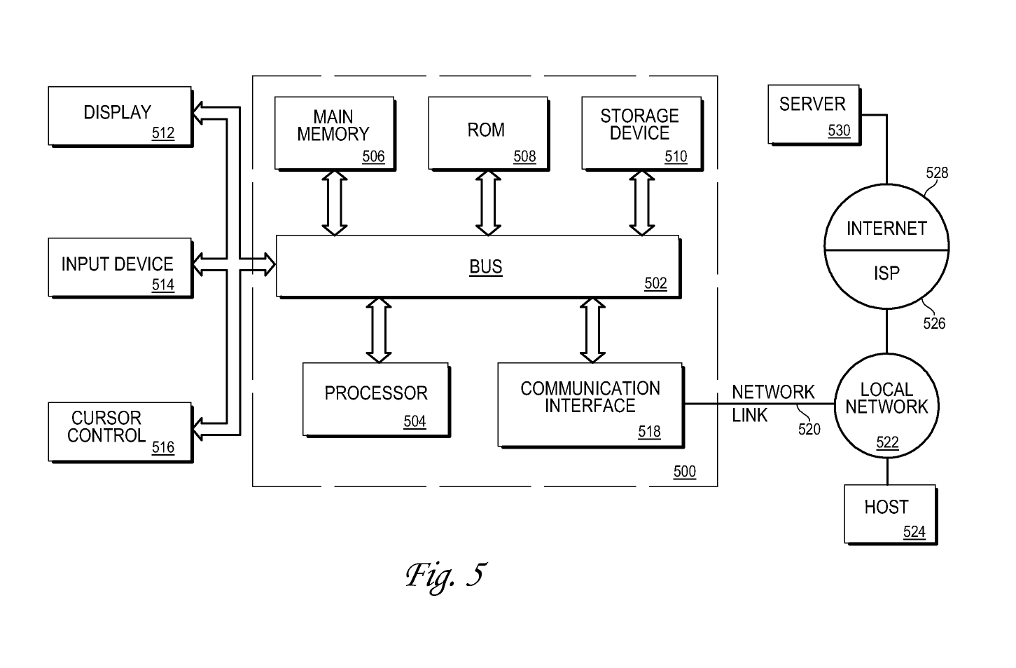

With reference to FIG. 4, there is shown a block diagram of a system 400 in which one embodiment of the present invention may be implemented. As shown, the system 400 may be coupled to a learner device 402, a wide area network or WAN 404 (e.g. the Internet, etc.), and a client device 406. For the sake of simplicity, only one learner device 402 and one client device 406 are shown, but it should be noted that, for purposes of the present invention, any desired number of learner and client devices may interact with the system 400. The learner device 402 and client device 406 may take on any of various forms, including but not limited to desktop computers, laptop computers, tablet computers, smartphones, mobile devices, etc. In one embodiment, the learner device 402 is used by a learner (e.g. a student) to interact with the system 400 to enable the learner to take advantage of educational resources provided by the system 400, and the client device 406 is used by a client (e.g. a professor, faculty member, educator, administrator, or other user of the system 400) to interact with the system 400 for various purposes, as will be elaborated upon below. The learner and client devices 402, 406 may execute a web browser or one or more dedicated applications in order to interact with the system 400. The learner device 402 and client device 406 may communicate with the system 400 via any type of connection or network (e.g. local area network, wide area network, etc.).

As shown, system 400 comprises a skills determiner 410. In one embodiment, it is the skills determiner 410 that performs the operations described previously in connection with FIGS. 2 and 3 to determine a set of desired skills for each of a plurality of employment positions, and to store the desired skills into a skills repository 418. As described previously, in determining a set of desired skills, a first set of skills and a second set of skills may be determined. The first set of skills may be determined by processing a plurality of job postings on a plurality of websites, and the set second set of skills may be determined by soliciting and receiving information from a plurality of employers.

To determine the first set of skills for each of a plurality of employment positions, the skills determiner 410 may access a plurality of websites 412, via WAN 404, and process a plurality of job postings available on those websites in the manner described previously. In processing the job postings, the skills determiner 410 may implement natural language processing to parse and “understand” the language used in the job postings; thus, the skills determiner 410 may comprise a natural language processing engine. For purposes of the present invention, any commercially available or custom natural language processing engine may be used. Alternatively, the skills determiner 410 may use some other type of language processor to parse and process the words in the job postings. For purposes of the present invention, any type of language processor may be used by the skills determiner 410.

To determine the second set of skills for each of a plurality of employment positions, the skills determiner 410 may send one or more questionnaires to a plurality of employers 414, via WAN 404, receive a plurality of responses from the employers 414, and process the responses to determine the second set of skills. Also, the skills determiner 410 may send an email to the employers 414, via WAN 404, with a link to a questionnaire that is hosted on a website. The employers can click on the link to access the questionnaire and provide the employment information that is being solicited. In such a case, the skills determiner 410 may be the component that sends the email and hosts the website of the questionnaire to collect the information from the employers 414. After receiving the information from the employers 414, the skills determiner 410 may process the information in the manner described previously to determine a second set of skills for each of a plurality of employment positions.

As noted previously, the second set of skills may also be determined by conducting live interviews with employers. In such a case, the results of the live interviews may be gathered by one or more users and provided to the skills determiner 410 through client device 406 and interface 416. The skills determiner 410 may thereafter use the results of the live interviews as the second set of skills, or may use the results of the live interviews to determine the second set of skills for each of a plurality of employment positions.

Once it has the first and second sets of skills for each of a plurality of employment positions, the skills determiner 410 may use the first and second sets of skills to determine, in the manner described previously, a set of desired skills for each of the plurality of employment positions. Each set of desired skills may be ranked and indexed. Once determined, the sets of desired skills may be stored by the skills determiner 410 into the skills repository 418 in such a manner that each set of desired skills is associated with a particular employment position. Associated in this manner, each set of desired skills can be easily accessed and obtained given a certain employment position. If so desired, the skills determiner 410 may store all of the skills in a set of desired skills into the skills repository 418. Alternatively, the skills determiner 410 may store just a subset of the skills in a set of desired skills (e.g. those having an index value above a certain threshold) into the skills repository. For purposes of the present invention, the skills repository 418 may take the form of any type of repository (e.g. relational database, flat, hierarchical or other type of database, lists, other data structures, etc.).

As an alternative to being determined by skills generator 410, the sets of desired skills may be provided by an external component or a user instead. In the case where the sets of desired skills are provided by an external component, the sets of desired skills may be received from the external component by interface 416 via WAN 404, and the interface 416 may store the sets of desired skills into the skills repository 418. In the case where the sets of desired skills are provided by a user, the sets of desired skills may be received by the interface 416 via client device 406, and the interface 416 may store the sets of desired skills into the skills repository 418. However the sets of desired skills make their way into the skills repository 418, once they are in the skills repository 418, they may be used to automatically generate a tailored curriculum for one or more particular employment positions.

System 400 further comprises a curriculum generator 420. In one embodiment, it is the curriculum generator 420 that performs the operations described above in connection with FIG. 1 to automatically generate a curriculum for a particular employment position. In one embodiment, the curriculum generator 420 may generate a curriculum for a particular employment position by initially obtaining from the skills repository 418 a set of desired skills associated with the particular employment position. The curriculum generator 420 may obtain the set of desired skills, for example, by querying the skills repository 418 for all desired skills associated with the particular employment position, or by searching through the contents of the skills repository 418 for all desired skills associated with the particular employment position. The curriculum generator 420 may use the set of desired skills as a set of key skills for the particular employment position, or it may perform some filtering operation on the set of desired skills (e.g. to filter out the skills that have an index value below a certain threshold) to derive a set of key skills for the particular employment position. Once the set of key skills is obtained, the curriculum generator 420 may use the set of key skills to automatically generate a curriculum that is tailored for the particular employment position.

Specifically, in one embodiment, for each key skill in the set of key skills, the curriculum generator 420 selects from a course repository 422 one or more courses that teach that key skill. The selected course(s) is included in the curriculum. To include a course in the curriculum, the curriculum generator 420 may store some information pertaining to that course, such as, for example, a course identifier, a course description, a name of a teacher or professor, a department identifier, etc. The curriculum generator 420 repeats this process for each of the key skills in the set of key skills Thus, by the end of the process, the curriculum will include at least one course for teaching each of the key skills associated with the particular employment position. Consequently, this curriculum will teach a student all of the key skills that the student will need in order to perform well at the particular employment position. Once generated, the curriculum may be stored by the curriculum generator 420 into a curriculum repository 424 for later use.

In one embodiment, to enable the curriculum generator 420 to easily select courses that teach certain skills, each course in the course repository 422 has a set of information associated therewith that indicates the one or more skills that are taught by that course. This set of information may, for example, be a set of metadata that is associated with a course. This metadata may, for example, take the form of a description of a course, or take the form of a list of one or more skills taught by the course. Whatever form the metadata takes, it provides the curriculum generator 420 with the information that it needs to determine which course teaches which skill or skills By processing the metadata, the curriculum generator 420 can determine, for each key skill, which course or courses teach that key skill, and hence, decide which course or courses to select for inclusion in a curriculum. In one embodiment, the courses in the course repository 422 are designed by educators to teach specific skills that correlate closely to the skills that are determined from processing the websites and processing the information from the employers. Thus, the courses are well suited for inclusion in curricula that are generated for employment positions based upon desired or required skills. The information in the course repository 422 may be provided by one or more users (e.g. educators, etc.) via client device 406 and interface 416. For purposes of the present invention, the course repository 422 may contain just basic information about each course (e.g. course identifier, professor, metadata, description, etc.) or it may contain all of the information pertaining to each course, including the actual content (e.g. reading materials, audio/visual content, tutorials, exams, etc.) of each course.

The curriculum generator 420 may generate curricula in batches or one at a time. For example, the curriculum generator 402 may cycle through each of the employment positions in the skills repository 418 for which there is a set of desired skills and automatically generate a curriculum for each employment position. Alternatively, the curriculum generator 420 may generate a curriculum only when requested. For example, a course engine 430 may present to a student (via learner device 402) a list of employment positions for which courses are available. When the student selects a particular employment position, the course engine 430 may send a request to the curriculum generator 420 to have the curriculum generator 420 automatically generate a curriculum for that employment position. By generating a curriculum on demand, it is ensured that the curriculum will have the most current courses (course information in the course repository 422 may change over time). Course curricula may be generated in these and other ways.

Once a course curriculum is generated, it may be used by the course engine 430 to educate a student via learner device 402. For example, the course engine 430 may enable the student to access, from the course repository 422, the course materials for the courses that are within a curriculum for a particular employment position. Once the student has studied all of the materials from all of the courses, the course engine 430 may administer one or more exams to determine whether the student has mastered all of the skills desired or required by the particular employment position. If the student is deficient in one or more skills desired or required by the particular employment position, then the course engine 430 may recommend that the student retake one or more courses or take one or more additional courses that teach the one or more skills in which the student is deficient.

In one embodiment, system 400 may be implemented as one or more computer systems. If the system 400 is implemented as multiple computer systems, then the multiple computer systems may be implemented as a cluster, wherein the various computer systems communicate and cooperate with each other. Each of the computer systems may, for example, take the form shown in FIG. 5 (which will be discussed in a later section). If the system 400 is implemented using a single computer system, then all of the components shown in FIG. 4 as being within the system 400 may be executed or implemented on that single computer system. If the system 400 is implemented using a plurality of computer systems, then the components shown in FIG. 4 as being within the system 400 may be executed/implemented in any desired combination on the various computer systems. For example, the skills determiner 410, curriculum generator 420, course engine 430, skills repository 418, course repository 422, etc., may each be executed/implemented on a separate computer system, or some may be executed/implemented on one computer system while others are executed/implemented on other computer systems. For purposes of the present invention, components 410, 416, 418, 420, 422, 424, and 430 may be executed/implemented on any computer system in any desired combination. Other components not shown in FIG. 4 may also execute on the one or more computer systems.

### Hardware Overview

With reference to FIG. 5, there is shown a block diagram of a computer system that may be used to implement at least a portion of the present invention. Computer system 500 includes a bus 502 or other communication mechanism for communicating information, and one or more hardware processors 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques and components (e.g. skills determiner 410, curriculum generator 420, course engine 430, skills repository 418, course repository 422, etc.) described herein using customized hard-wired logic, one or more ASICs or FPGAs, firmware and/or program logic which in combination with the computer system causes or programs computer system 500 to be a special-purpose machine. According to one embodiment, the techniques disclosed herein for skills determiner 410, curriculum generator 420, and course engine 430 are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

At this point, it should be noted that although the invention has been described with reference to specific embodiments, it should not be construed to be so limited. Various modifications may be made by those of ordinary skill in the art with the benefit of this disclosure without departing from the spirit of the invention. Thus, the invention should not be limited by the specific embodiments used to illustrate it but only by the scope of the issued claims.

What is claimed is:

1. A method, comprising:
obtaining, from a skills repository, a set of key skills associated with a particular employment position; and
automatically generating a curriculum that is tailored for the particular employment position, wherein generating the curriculum comprises:
for each key skill in the set of key skills:
selecting, from a course repository, at least one course that teaches that key skill; and
including the selected course in the curriculum;
wherein the curriculum includes at least one course for teaching each key skill in the set of key skills; and
wherein the method is performed by one or more computing systems.

2. The method of claim 1, further comprising:
determining a set of desired skills for the particular employment position; and
storing the set of desired skills into the skills repository in a manner that indicates that the set of desired skills is associated with the particular employment position;
wherein the set of desired skills may be the same as the set of key skills or a superset of the set of key skills.

3. The method of claim 2, wherein determining the set of desired skills for the particular employment position comprises:
deriving the set of desired skills based, at least in part, upon a first set of skills associated with the particular employment position and a second set of skills associated with the particular employment position, wherein the first set of skills is determined based upon objective information and the second set of skills is determined based upon subjective information from employers.

4. The method of claim 2, wherein determining the set of desired skills for the particular employment position comprises:
accessing, on a plurality of websites, a plurality of employment postings, wherein each of the plurality of employment postings comprises a description of an opening for the particular employment position; and
processing the descriptions of the plurality of employment postings to extract therefrom a set of skills that are associated with the particular employment position.

5. The method of claim 2, wherein determining the set of desired skills comprises:
sending an electronic message, having a link to a questionnaire on a website, to a plurality of employers to solicit input from the plurality of employers on what skills are desired for the particular employment position;
receiving a plurality of sets of information from at least a subset of the plurality of employers, wherein each set of information comprises information from an employer indicating a set of skills desired by that employer for the particular employment position; and
processing the plurality of sets of information to derive a set of skills that are associated with the particular employment position.

6. The method of claim 2, wherein determining the set of desired skills comprises:
receiving a plurality of sets of information from a plurality of employers, wherein each set of information comprises information from an employer indicating a set of skills desired by that employer for the particular employment position; and
processing the plurality of sets of information to derive a set of skills that are associated with the particular employment position.

7. The method of claim 2, wherein determining the set of desired skills for the particular employment position comprises:
accessing, on a plurality of websites, a plurality of employment postings, wherein each of the plurality of employment postings comprises a description of an opening for the particular employment position;
processing the descriptions of the plurality of employment postings to extract therefrom a first set of skills that are desired for the particular employment position;
determining, based at least in part upon information from employers, a second set of skills that are desired by employers for the particular employment position; and
deriving the set of desired skills for the particular employment position based, at least in part, upon the first set of skills and the second set of skills.

8. The method of claim 7, wherein the skills in the first set of skills are indexed based, at least in part, upon how frequently each skill appears in the descriptions of the plurality of employment postings, wherein the skills in the second set of skills are indexed based, at least in part, upon ratings provided by the employers, and wherein the skills in the set of desired skills are indexed based, at least in part, upon how the skills in the first set of skills are indexed and how the skills in the second set of skills are indexed.

9. The method of claim 8, wherein in indexing the skills in the set of desired skills, greater weight is given to how the skills in the second set of skills are indexed than to how the skills in the first set of skills are indexed.

10. The method of claim 1, further comprising:
administering one or more tests to a student to test the student's mastery of the curriculum;
determining, based at least in part upon results of the one or more tests, whether the student is deficient in one or more key skills in the set of key skills; and
in response to a determination that the student is deficient in at least one of the key skills in the set of key skills, recommending that the student retake a course or take an additional course that teaches the at least one key skill in which the student is deficient.

11. A system comprising one or more computer systems, wherein the one or more computer systems are configured to perform the operations of:
obtaining, from a skills repository, a set of key skills associated with a particular employment position; and
automatically generating a curriculum that is tailored for the particular employment position, wherein generating the curriculum comprises:
for each key skill in the set of key skills:
selecting, from a course repository, at least one course that teaches that key skill; and
including the selected course in the curriculum;
wherein the curriculum includes at least one course for teaching each key skill in the set of key skills.

12. The system of claim 11, wherein the one or more computer systems are configured to further perform the operations of:
determining a set of desired skills for the particular employment position; and
storing the set of desired skills into the skills repository in a manner that indicates that the set of desired skills is associated with the particular employment position;
wherein the set of desired skills may be the same as the set of key skills or a superset of the set of key skills.

13. The system of claim 12, wherein determining the set of desired skills for the particular employment position comprises:
deriving the set of desired skills based, at least in part, upon a first set of skills associated with the particular employment position and a second set of skills associated with the particular employment position, wherein the first set of skills is determined based upon objective information and the second set of skills is determined based upon subjective information from employers.

14. The system of claim 12, wherein determining the set of desired skills for the particular employment position comprises:
accessing, on a plurality of websites, a plurality of employment postings, wherein each of the plurality of employment postings comprises a description of an opening for the particular employment position; and
processing the descriptions of the plurality of employment postings to extract therefrom a set of skills that are associated with the particular employment position.

15. The system of claim 12, wherein determining the set of desired skills comprises:
sending an electronic message, having a link to a questionnaire on a website, to a plurality of employers to solicit input from the plurality of employers on what skills are desired for the particular employment position;
receiving a plurality of sets of information from at least a subset of the plurality of employers, wherein each set of information comprises information from an employer indicating a set of skills desired by that employer for the particular employment position; and
processing the plurality of sets of information to derive a set of skills that are associated with the particular employment position.

16. The system of claim 12, wherein determining the set of desired skills comprises:
receiving a plurality of sets of information from a plurality of employers, wherein each set of information comprises information from an employer indicating a set of skills desired by that employer for the particular employment position; and
processing the plurality of sets of information to derive a set of skills that are associated with the particular employment position.

17. The system of claim 12, wherein determining the set of desired skills for the particular employment position comprises:
accessing, on a plurality of websites, a plurality of employment postings, wherein each of the plurality of employment postings comprises a description of an opening for the particular employment position;
processing the descriptions of the plurality of employment postings to extract therefrom a first set of skills that are desired for the particular employment position;
determining, based at least in part upon information from employers, a second set of skills that are desired by employers for the particular employment position; and
deriving the set of desired skills for the particular employment position based, at least in part, upon the first set of skills and the second set of skills.

18. The system of claim 17, wherein the skills in the first set of skills are indexed based, at least in part, upon how frequently each skill appears in the descriptions of the plurality of employment postings, wherein the skills in the second set of skills are indexed based, at least in part, upon ratings provided by the employers, and wherein the skills in the set of desired skills are indexed based, at least in part, upon how the skills in the first set of skills are indexed and how the skills in the second set of skills are indexed.

19. The system of claim 18, wherein in indexing the skills in the set of desired skills, greater weight is given to how the skills in the second set of skills are indexed than to how the skills in the first set of skills are indexed.

20. The system of claim 11, wherein the one or more computer systems are configured to further perform the operations of:
administering one or more tests to a student to test the student's mastery of the curriculum;
determining, based at least in part upon results of the one or more tests, whether the student is deficient in one or more key skills in the set of key skills; and
in response to a determination that the student is deficient in at least one of the key skills in the set of key skills, recommending that the student retake a course or take an additional course that teaches the at least one key skill in which the student is deficient.
